(19) United States
(12) Patent Application Publication
(10) Pub. No.: US 2024/0410161 A1
(43) Pub. Date: Dec. 12, 2024

(54) Hybrid Joint Assembly

(71) Applicant: Produktif Norway AS, Raufoss (NO)

(72) Inventor: Rune Kongshaug, Averöya (NO)

(21) Appl. No.: 18/697,115

(22) PCT Filed: Sep. 29, 2022
(86) PCT No.: PCT/NO2022/050224

§ 371 Date: Mar. 29, 2024

(30) Foreign Application Priority Data
Sep. 30, 2021 (NO) 20211173

(51) Int. Cl. E04B 1/38

(52) U.S. Cl. CPC E04B 1/388

(57) ABSTRACT

Hybrid joint assembly comprising at least one cylinder-shaped joint assembly comprising an elongated or disc-shaped main body provided with exterior connection surfaces for attachment of structure elements extending in a horizontal plane via a connection interface, and at longitudinal ends thereof adapted for connection to structure elements extending in a vertical plane via a connection disc or structure elements extending in a parallel vertical plane via a rotational connection module and at least one connection module.

### BACKGROUND

The disclosed embodiments are related to a hybrid joint assembly, and especially related to a hybrid joint assembly making use of universal and mass-customizable parts enabling multiple opportunities for connection of structure elements in the vertical plane and horizontal plane.

Tomorrow's demands on the construction sector will require systemic and sustainable resource management with fully integrated production and distribution.

It further demands a lower environmental footprint for each construction. It is thus a requirement of construction systems to reduce the pollution and waste, preferably to facilitate a zero-waste circular economy.

Over the years there have been made several attempts to provide a construction system with the attempt of simplifying the assembly of a structure construction.

A disadvantage of many of the existing solutions is that they require many parts for connection or special tools for assembly and disassembly.

A further disadvantage of the existing solutions is that they are not scalable in a simple manner.

A further disadvantage of many of the existing solutions is that they rely on threaded connections that can be cross-threaded, and thus damage the part and undermine the integrity of the joint.

A further disadvantage of the existing solutions is that most solutions have fixed dimensions of beams or struts, which limit the ability to create unique or custom designs. The final shape of the structure is limited to a few basic configurations such as a cube, pyramid, or rectangle of fixed size.

A further disadvantage is that many of the existing solutions do not have the capability to carry services such as water, power, or data signals through the beams/struts and joints.

There is accordingly a need for a hybrid joint assembly addressing these issues of the existing solutions.

### SUMMARY

Disclosed herein is a hybrid joint assembly partly or entirely solving the drawbacks of existing solutions and/or the mentioned needs.

The disclosed hybrid joint assembly can be formed of mass-produced standard parts that are ready-to-assemble onsite or offsite.

Also provided is a hybrid joint assembly enabling manual assembly (onsite or offsite) that is tool-less or requires minimal tools at assembly.

Also provided is a hybrid joint assembly enabling mass-customization using standard and interchangeable parts that can be configured intuitively for different/custom applications.

Also provided is a hybrid joint assembly enabling both assembly and disassembly in a simple manner.

Also provided is a hybrid joint assembly designed for effective packaging and shipment.

Also provided is a hybrid joint assembly resulting in a minimal environmental footprint.

Additionally, the disclosed hybrid joint assembly may be modular and scalable.

Further, the hybrid joint assembly may be disassembled and re-used in another construction.

The hybrid joint assembly may additionally provide conduit or channel paths for services such as water, power and data signal transmission within or in connection with structure elements.

Additionally, the hybrid joint assembly may be used to create structures that can withstand the loads and moments exerted on permanent structures by natural and manmade forces and usage.

The disclosed hybrid joint assembly enables connection to mainframe or a construction system for assembly of a structural construction that is easily adapted on the building site.

The hybrid joint assembly comprises at least one cylinder-shaped joint assembly (CSJA) comprising an elongated or disc-shaped main body provided with exterior connection surfaces for attachment of structure elements extending in a horizontal plane via a connection interfaces. The CSJA further is at longitudinal ends thereof adapted for connection to structure elements extending in a vertical plane via a connection means/disc or connection to structure elements extending in a parallel vertical plane via a rotational connection module and at least one connection module.

In accordance with one embodiment, the hybrid joint assembly comprises internal locking devices adapted for detachable locking of the connection disc or rotational connection module to the CSJA.

According to another embodiment, the mentioned connection interface comprises a dual tenon fork connection and locking device with wider heads detachably arranged to the connection surface via the connection interface at one end, and adapted to be received in a structure element connection interface or an adapted receptor of a structure element for arrangement of a structure element thereto.

In accordance with a further embodiment, the internal locking device comprises a main body and from one end thereof extending dual tenon fork connection and locking device with wider heads.

According to one embodiment, the mentioned CSJA, connection disc and rotational connection module are provided with respective upper and/or lower recesses or flanges adapted to receive and accommodate the main body of the internal locking device.

In accordance with a further embodiment, the CSJA, connection disc and rotational connection module are provided with respective flanges adapted to retain the wider heads of the internal locking device.

In a further embodiment, the CSJA is provided with a projection at each end, and wherein the connection disc, internal locking device and connection module are provided with respective recesses adapted for receiving and accommodating the projection at arrangement to the CSJA.

According to a further embodiment, the rotational connection module at one end is adapted for connection to the CSJA and at the other end is provided with an oblique surface wherein a rotational locking device is arranged.

In accordance with a further embodiment, the rotational locking device comprises a ball joint and a cone-shaped locking member, wherein the ball-joint is accommodated spatially rotational in the rotational locking device and the cone-shaped locking member protrudes from the oblique surface.

According to a further embodiment, a cone-shaped locking member is a dual tenon fork connection and locking mechanism with wider heads.

In a further embodiment, the mentioned connection module at vertical sides thereof is provided with corresponding interlocking profiles enabling attachment to corresponding adjoining connection modules.

In accordance with a further embodiment, the mentioned connection module at lower side thereof is provided a corresponding interlocking profile enabling attachment to adjoining connection modules with the lower sides facing each other or connection to longitudinal ends of the CSJA.

According to a further embodiment, the interlocking profile at lower side is provided with a slot or recess adapted for accommodating the projection of the CSJA.

In accordance with one embodiment, the interlocking profile at lower side is at inner end limited by an internal annular flange, wherein the internal annular flange is adapted to retain the wider heads of the internal locking device.

In a further embodiment, the connection module is provided a through-hole at an oblique surface adapted connection with the cone-shaped locking member of the rotational connection module, and wherein the oblique surface corresponds to the oblique surface of the rotational connection module.

According to a one embodiment, the hybrid joint assembly further comprises at least one mainframe column connection assembly comprising upper and lower profiled connection interfaces and formed as one piece or upper and lower connection members adapted for detachable connection to each other.

According to a further embodiment, the mainframe column connection assembly at upper end is provided with an upper connection device for arrangement to a vertical structure element via an adapted connection interface and/or at lower end provided with connection device for arrangement to a vertical structure element via an adapted connection interface.

In accordance with a further embodiment, the upper connection member at lower end is provided with longitudinally extending elongated centered profiled recess, adapted for receiving and accommodating an upper part of the lower connection member.

In a further embodiment, the connection module is provided with locking profile at rear vertical side thereof adapted for connection to the corresponding profiled connection interface of a mainframe column connection assembly.

In accordance with a further embodiment, the connection interface at one end is provided with recesses for receiving the dual tenon for connection and locking device and at the other end a connection member for connection to a structure element.

The inventive embodiments provide a hybrid joint assembly enabling arrangement of structure in different vertical or horizontal planes. They also further enable arrangement of structures in parallel vertical planes or parallel horizontal planes.

By the disclosed hybrid joint assembly, it will be possible to have a corner on top without a corner aligned directly underneath or vice versa, one can have a corner on the bottom without one directly on top, etc.

The hybrid joint assembly is formed by components that easily is exchanged to exhibit desired properties onsite during building.

The disclosed embodiments enable, due to the properties of the components, forming of several corners/connection surfaces, enabling arrangement of structures in one or more vertical planes.

The disclosed embodiments further enable, due to the properties of the components, enabling arrangement of structures in one or more horizontal planes.

Further preferable features and advantageous details of the disclosed embodiments will appear from the following example description, claims and attached drawings.

### BRIEF DESCRIPTION OF THE DRAWINGS

The present invention will now be described in further detail with references to the attached drawings, where:

FIGS. 1A-1C are principle drawings of different embodiments of the disclosed hybrid joint assembly,

FIGS. 2A-2C and 3 are principle drawings of embodiments of a cylinder-shaped joint assembly,

FIGS. 4A and 4B are principle drawings of connection interfaces according to the disclosed embodiments,

FIG. 5 is a principle drawing of a lock bolt according to the disclosed embodiments,

FIGS. 6A and 6B are principle drawings of a connection disc according to the disclosure,

FIG. 7 is a principle drawing of an internal locking device according to the disclosure,

FIGS. 8A-8G are principle drawings of rotational connection module according to the disclosure,

FIGS. 9A-9G are principle drawings of different embodiments of a connection module according to the disclosure,

FIG. 10 is a principle drawing of an example of a structure element applicable with the disclosed embodiments,

FIGS. 11A-11C are principle drawings of different embodiments of connection interfaces,

FIGS. 12A and 12B are principle drawings of a mainframe column connection assembly according to the disclosed embodiments,

FIG. 13 is a principle drawing of a connection interface to the mainframe column connection assembly according to the disclosure, and

FIGS. 14A-14D are principle drawings showing principle drawing of the use of the hybrid joint assembly according to the disclosure to enable connection to a mainframe structure.

### DETAILED DESCRIPTION

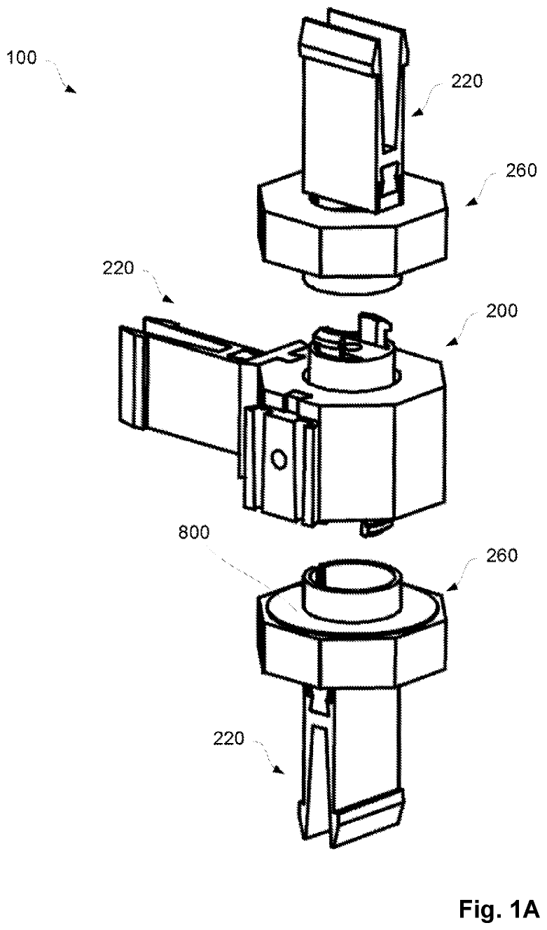

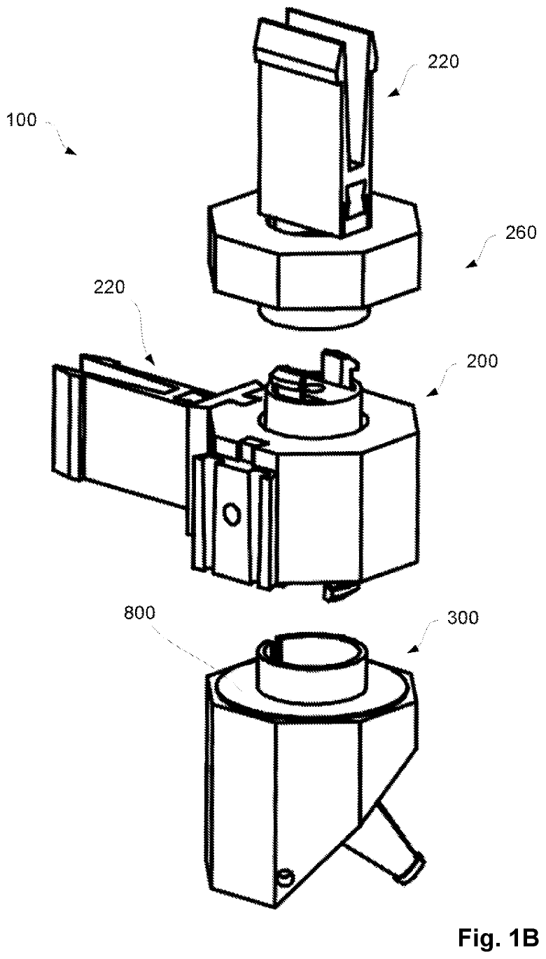

Reference is now made to FIGS. 1A-1C showing principle drawings of different embodiments of a hybrid joint assembly 100.

The hybrid joint assembly 100 disclosed herein comprises one more of: a cylinder-shaped joint assembly 200, a rotational connection module 300 and a connection module 400 enabling arrangement to a mainframe column structure by means of at least one mainframe column connection assembly.

The hybrid joint assembly 100 further comprises internal locking devices 260 for locking the respective part to each other.

The hybrid joint assembly 100 further comprises one or more means 250 for connection to structure elements in the vertical plane and one or more means 220 for connection of structure elements in the horizontal plane.

Accordingly, the hybrid joint assembly 100 according to the disclosure comprises a number of modules or devices that can be configured to enable connection to mainframe column structure and in addition enabling multiple connections for structure elements in the vertical and/or horizontal plane, as required on a construction site.

The hybrid joint assembly 100 comprises at least one cylinder-shaped joint assembly (CSJA) 200 formed by an elongated or disc-shaped main body 201. In the shown embodiment, the elongated or disc-shaped main body 201 is hollow and exhibits a round or polygonal exterior shape, in the shown example, an octagonal exterior shape, providing exterior connecting surfaces 202, that may either be rounded or flat, further described below. The elongated or disc-shaped main body 201 may also have a round exterior surface, but having rectangular flat/planar connection surfaces 202 resulting from a polygonal shape, will provide a higher degree of support for connection thereto and/or higher ease of manufacturability and/or higher ease of error-free assembly of individual parts into custom assemblies.

According to one embodiment, the connection surfaces 202 of the CSJA 200 is provided with longitudinal extending centered recesses 203, wherein the opening thereof is narrower than the bottom. In the shown embodiment the recess 203 has a trapezoidal cross-section, wherein longitudinal sides thereof are tapering inwards from the bottom towards the opening thereof.

According to the disclosure, the CSJA 200 further comprises at least one connection interface 210 enabling connection between the CSJA 200 and structure elements 500 (see FIG. 10) in a perpendicular plane of the CSJA 200 by means of a dual tenon fork connection and locking device 220, or enabling attachment of lifting hooks, ears or similar to the CSJA 200.

The connection interface 210 comprises a connection plate 211 adapted the exterior shape of the connection interface 202 for engagement therewith. Details of the connection plate 211 is shown in FIGS. 4A and 4B showing principle drawings of two different embodiments of the connection plate 211, adapted the dual tenon fork connection and locking device 220 and adapted arrangement of lifting hooks, ears or similar, respectively. The connection plate 211 is at rear end thereof provided with a longitudinally extending centred projection 212 adapted to be received and accommodated in the mentioned recess 203 by a sliding movement from one end thereof. In the shown embodiments, the centered projection 212 has a trapezoidal cross-section, wherein the longitudinal sides thereof is tapering outwards from the rear side of the connection plate 211 towards the final end of the projection 212.

At the other side of the connection plate 211, the connection plate 211 is provided with means for connection of elements/components thereto. In the embodiment of FIG. 4A, the connection plate 211 is provided with a longitudinally extending centered lock bolt sleeve 213, which in the shown embodiment has a mainly rectangular cross-section, arranged to the connection plate 211 at one side thereof. The lock bolt sleeve 213 is at the other end provided with a longitudinally extending centered recess 214. In the shown embodiment the longitudinally extending recess 214 has a trapezoidal cross-section, wherein longitudinal sides thereof are tapering inwards from the bottom towards the opening thereof.

In the alternative embodiment of the connection interface 210, as shown in FIG. 4B, the connection plate 211 is provided with at least one longitudinally extending recess at the other side of the projection 212. In the shown embodiment, the connection plate 211 is provided with two parallel longitudinally extending recesses 214a-b, spaced apart in the transversal direction of the connection plate 211. As for the recess 214 of the first embodiment, the recesses 214a-b have a trapezoidal cross-section, wherein longitudinal sides thereof are tapering inwards from the bottom towards the opening thereof. The recesses 214a-b can thus be used to attaching lifting hooks, ears (not shown) or similar thereto.

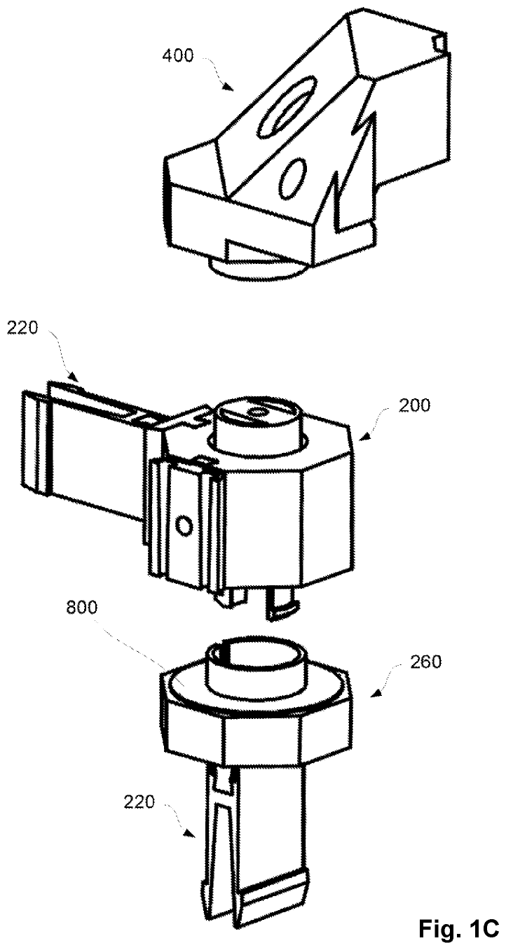

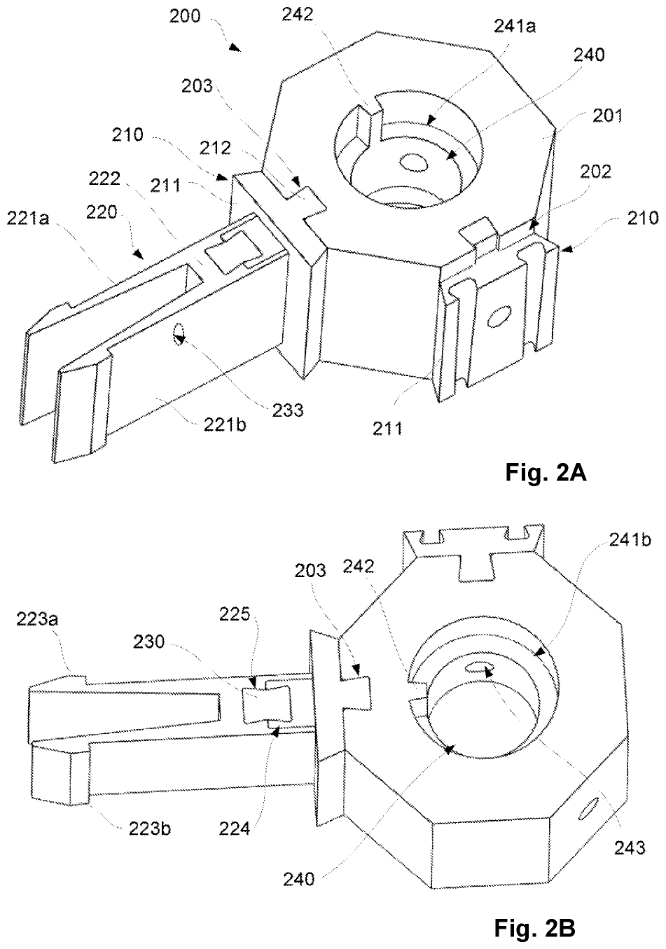

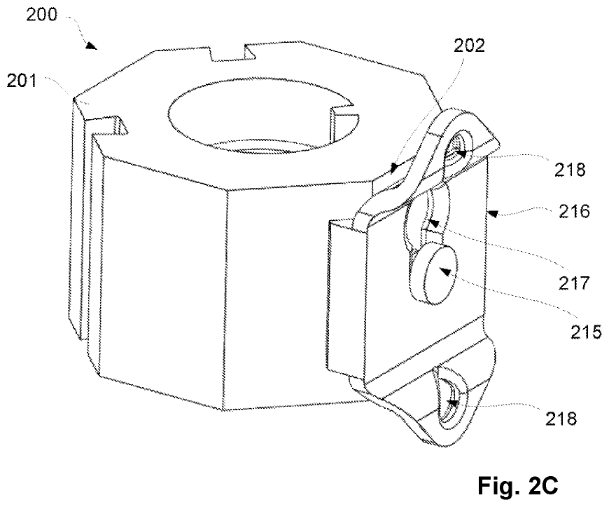

Reference is now made to FIG. 2C showing an alternative embodiment of the CSJA 200, wherein the elongated or disc-shaped main body 201 at one connecting surface 202 is provided with a perpendicularly protruding pin 215 with wider head at the free end thereof adapted for connection of a detachable lifting hook, ear or similar 216. In the shown embodiment, the detachable lifting hook, ear or similar 216 is a mainly rectangular plate with a connection recess 217 exhibiting two different diameters, wherein one is adapted to allow arrangement of the lifting hook, ear or similar 216 to the pin 215, while the other has smaller diameter than the wider head of the pin 215, securing the lifting hook, ear or similar 216 to the CSJA 200. The detachable lifting hook, ear or similar 216 is further provided with connection holes 218 for attachment to lifting or hoisting equipment.

Reference is again made to FIGS. 2A and 2B. The dual tenon fork connection and locking device 220 enables connection of structure elements in the horizontal plane to the CSJA 200. An advantage with the dual tenon fork connection and locking device 220 is that it has no moving mechanical parts. The dual tenon fork connection and locking device 220 is formed by two parallel extending tenon forks 221a-b connected at rear end thereof by a main body 222, wherein the tenon forks 221a-b at the free end thereof are provided with respective wider heads 223a-b. The mentioned tenon forks 221a-b exhibit a pretensions force, such that the bending of the two tenon forks 221a-b allows for narrowing of the wider heads 223a-b when entering a recess 603 of a connection interface 600 or an adapted receptor of a structure element 500 and widening when it clears passage and enters a wider inner spacing. The wider head 223a-b grips onto inner surface of the wider inner spacing and secures the connection interface 600 or structure element 500 thereto.

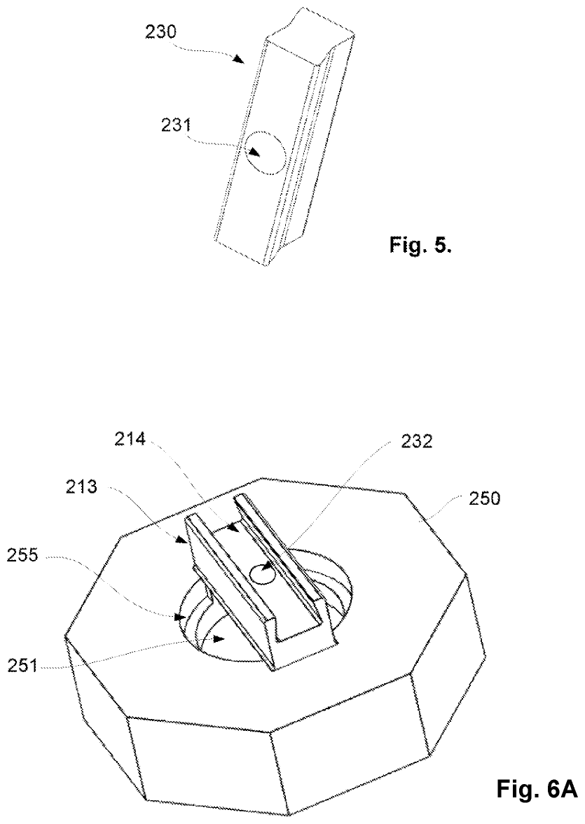

The dual tenon fork connection and locking device 220 is at rear end thereof provided with a recess 224 adapted the mentioned lock bolt sleeve 213 of the connection plate 211. The recess 224 is further at bottom thereof provided with a further recess 225 with a corresponding shape, size and cross-section as the mentioned recess 214 of the lock bolt sleeve 213. In this manner, when the dual tenon fork connection and locking device 220 is arranged to the CSJA 200, the mentioned recesses 214 and 225 together form a mainly rectangular lock bolt recess with a double trapezoidal cross-section, i.e. trapezoidal cross-section mirrored over a longitudinal center axis thereof, adapted for receiving a locking bolt 230 of corresponding shape. The locking bolt 230 according to one embodiment is shown in detail in FIG. 5. As for the mentioned formed lock bolt recess, the locking bolt 230 exhibits a mainly rectangular shape with a double trapezoidal cross-section, i.e. trapezoidal cross-section mirrored over a longitudinal center axis thereof.

In this manner, the dual tenon fork connection and locking device 220 can be secured to the connection plate 211 and thus the CSJA 200 by sliding the mentioned locking bolt 230 into the mentioned lock bolt recess from one end thereof.

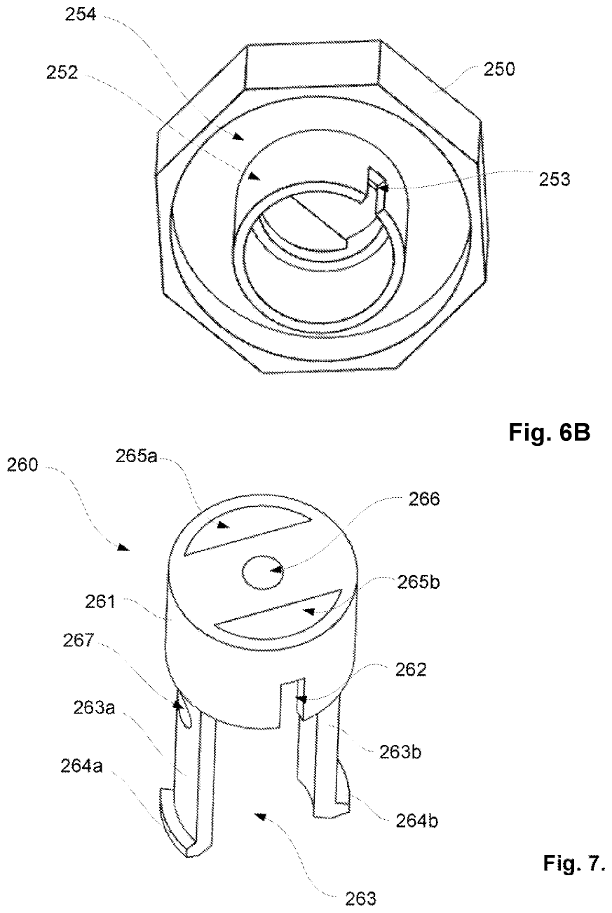

Reference is again made to FIGS. 2A, 2B, 6A and 6B. The CSJA 200 is further adapted for arrangement of structure elements in longitudinal direction thereof, i.e. at the ends thereof, enabling arrangement of structure elements in the vertical plane.

According to the disclosure, the CSJA 200 is provided with a through hole 240. The through hole 240 of the CSJA 200 is surround by a respective annular flange 241a-b extending with a limited depth from each end of the CSJA 200, and wherein the respective annular flange 241a-b is not complete, but exhibit a small part 242 forming a projection of a desired size, further described below.

As shown, it may comprise a connection disc 250 adapted for connection to the ends of the CSJA 200. The connection disc 250 may have a polygonal exterior shape corresponding to the exterior shape of the CSJA 200. In the shown example, the connection disc 250 has an octagonal exterior shape.

The connection disc 250 is provided with centered through hole 251, at lower side of the connection disc 250 surrounded by an annular flange 252 with a size and length adapted the size and length of the mentioned annular recess 241a-b of the CSJA 200. The mentioned annular flange 252 is provided with a longitudinally extending slot or recess 253 adapted the size and length of the mentioned projection 242 of the annular flange 241a-b of the CSJA 200.

The mention annular flange 252 is further surrounded by an annular recesses 254 adapted for receiving a gasket 800, such as an expansion compression gasket. The gasket 800 will apply a pretension force on the adjoining parts and facilitate secure attachment of the two parts/components.

The connection disc 250 is further provided with an annular recess 255 surrounding the through hole 251 at upper part of the connection disc 250. The connection disc 250 is further at upper side provided with a lock bolt sleeve 213, similar as described above, extending in transversal direction of the mentioned through hole 251 and secured to the upper surface of the connection disc 250, leaving both sides of the mentioned recess 255 open. The height of the mentioned annular recess 255 is adapted the height of heads 264a-b of an internal locking device 260, further described below.

Reference is now made to FIG. 7 showing principle drawings of an internal locking device 260. The internal locking device 260 exhibit an elongated tubular shape and is adapted to be received in the mentioned connection disc 250 and CSJA 200. The internal locking device 260 is formed by a tubular solid main body 261 with a size and height adapted to be received in the through hole 251 of the connection disc 250, in the upper recess 241a of the CSJA 200 and in a rotational connection module 300, further described below. The tubular solid main body 261 is at lower end provided with a longitudinally extending slot or recess 262 adapted the size and length of the mentioned projection 242 of the annular flange 241a-b of the CSJA 200.

The tubular solid main body 261 is further provided with a dual tenon fork connection and locking device 263 having moving mechanical parts. The dual tenon fork connection and locking device 263 is formed by two parallel extending tenon forks 263a-b extending from lower end of the tubular solid body 261, wherein the tenon forks 263a-b at the free end thereof are provided with respective wider heads 264a-b. The mentioned tenon forks 263a-b exhibit a pretensions force, such that the bending of the two tenon forks 263a-b allows for narrowing of the head 264a-b when entering the through hole 240 of CSJA 200 and a widening when it clears passage, i.e. is received in the respective annular recess 241a-b. The wider head 264a-b grips onto inner surface of the respective annular recess 241a-b locking the parts together.

The mention tubular body 261 is further provided with longitudinally extending parallel through opening 265a-b adapted for receiving corresponding dual tenon forks 263a-b of a corresponding internal locking device 260 of an adjoining connection disc 260 or rotational connection module 300.

As for the CSJA 200, the connection disc 250 at upper side, via the lock bolt sleeve 213, can be provided with a similar dual tenon fork connection and locking device 220, as shown in FIGS. 1A-1C. The dual tenon fork connection and locking device 220 is than arranged in the longitudinal direction of the CSJA 200, thus enabling connection of structure elements in longitudinal direction of the CSJA 200 and in the vertical plane.

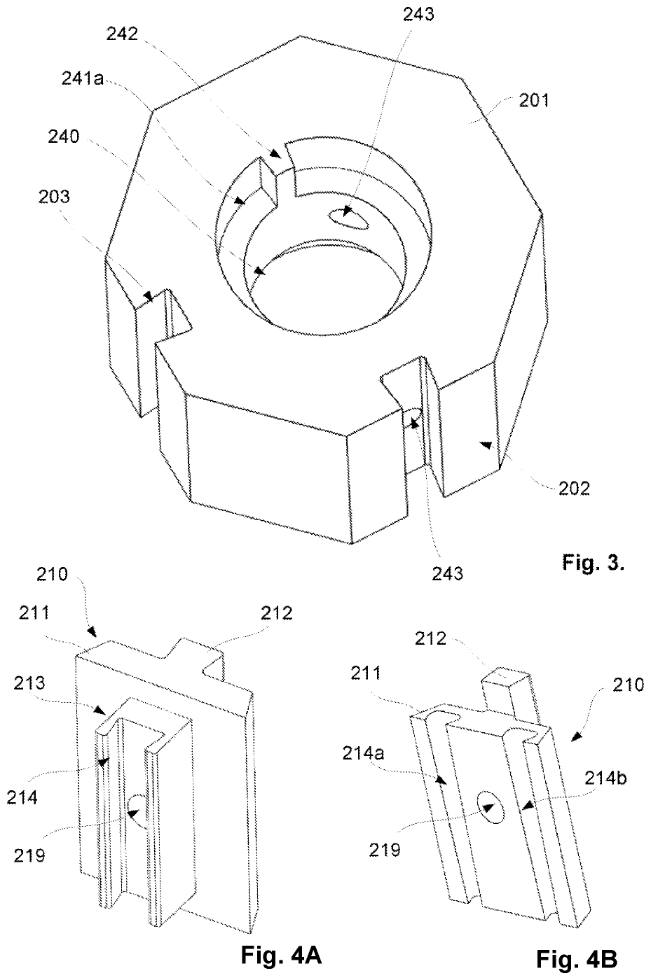

Accordingly, FIGS. 1A, 2A, 2B, 6A and 6B present a solution wherein structure elements may be arranged in longitudinal direction/vertical plane via the CSJA 200, while FIGS. 3, 4A and 4B present a solution where one also may arrange structure elements in a perpendicular plane of the CSJA 200, i.e. in the horizontal plane.

Accordingly, the connection discs 250 enables easy and precise connection to top or bottom of the mentioned CSJA 200.

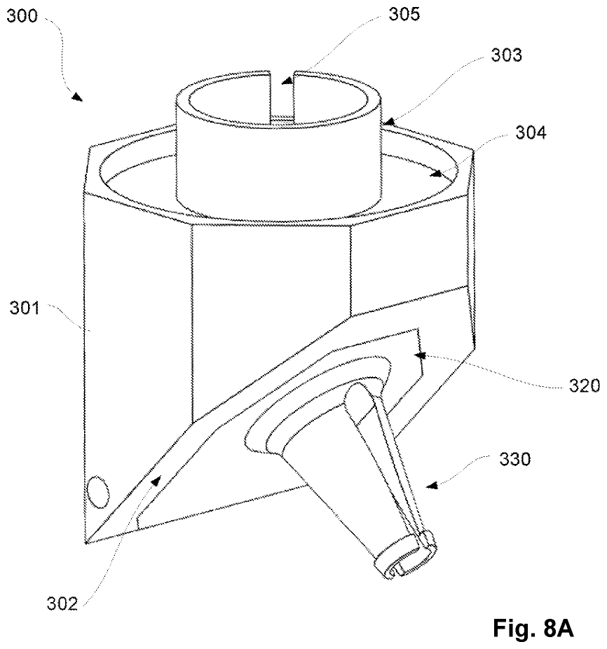

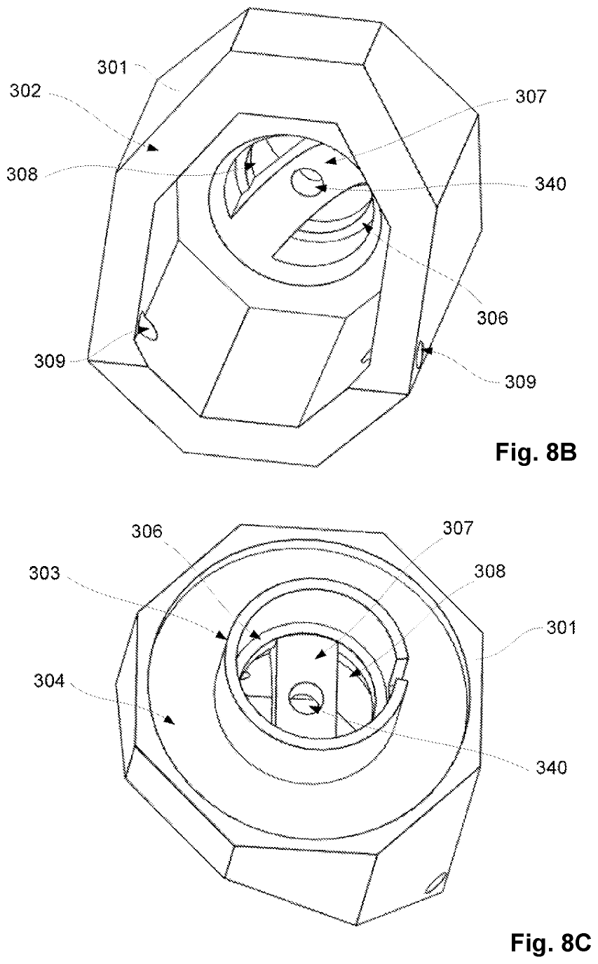

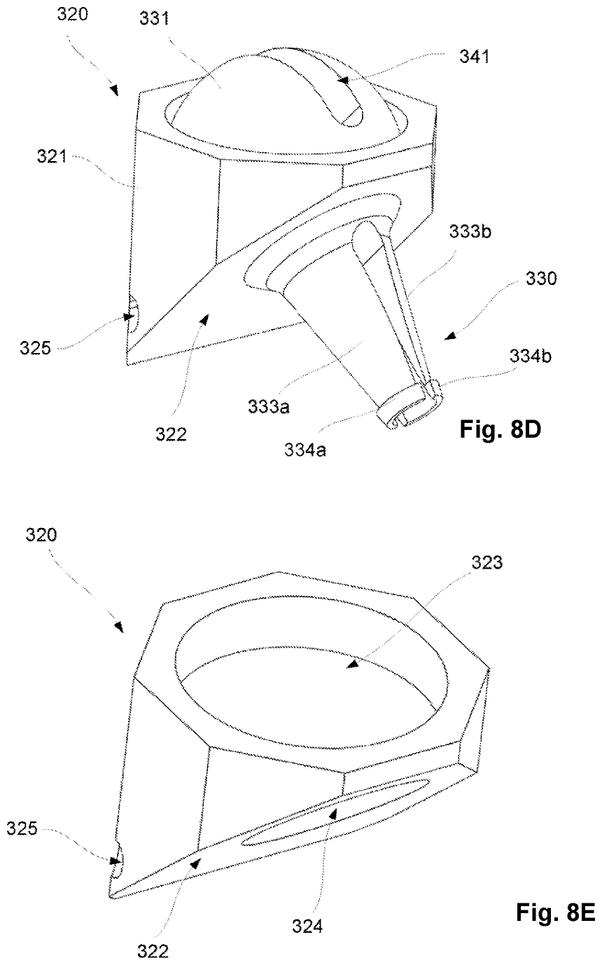

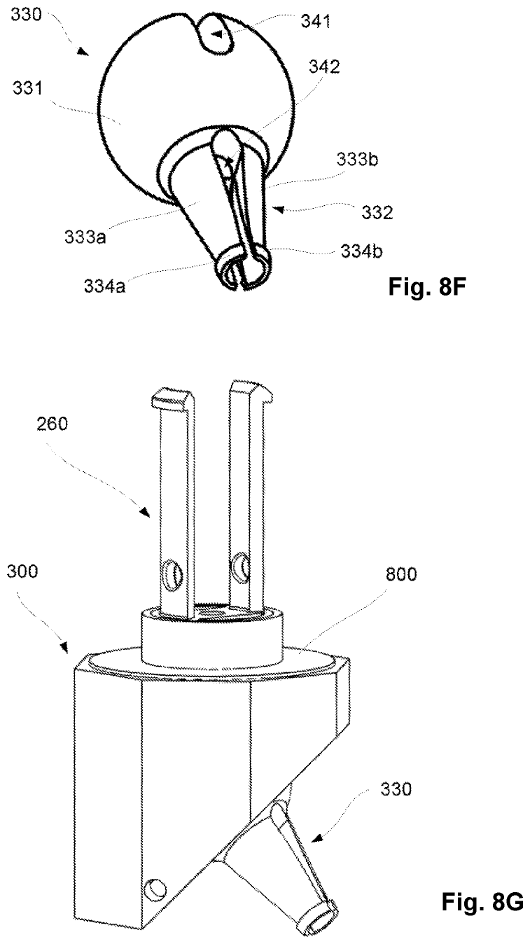

Reference is now made to FIGS. 8A-8G showing principle drawings of a rotational connection module 300. The rotational connection module 300 comprises a main body 301 shaped as truncated cylinder wherein on end 302 (lower end) thereof is an oblique surface, e.g. angled 45 degrees, also known as cut cylinder or a right circular cylinder with one oblique plane face. The main body 301 is further provided with a polygonal exterior shape, in the shown example an octagonal exterior shape, similar to the exterior shapes of the CSJA 200 and connection disc 250.

The main body 301 is provided with centered annular flange 303 at upper side thereof surrounded by an annular recess 304 adapted for receiving a gasket 800, such as an expansion compression gasket. The gasket 800 will apply a pretension force on the adjoining parts and facilitate secure attachment of the two parts/components. The size and length of the centered annular flange 303 is adapted the size and length mentioned annular recess 241a-b of the CSJA 200 for accommodation therein. The mentioned annular flange 303 is provided with a longitudinally extending slot or recess 305 adapted the size and length of the mentioned projection 242 of the annular flange 241a-b of the CSJA 200.

The mentioned annular flange 303 is at lower end limited by an internal annular flange 306 and a centered transversal beam 307 and adapted to receive the tubular solid main body 261 of the mentioned internal locking device 260. At each side of the centred transversal beam 307 are openings 308 adapted for receiving the tenon forks 263a-b with wider heads 264a-b of the internal locking device 260 and wherein the internal annular flange 306 is adapted to retain the mentioned wider heads 264a-b of the internal locking device 260. Arrangement of the internal locking device 260 to a rotational connection module 300 is shown in FIG. 8G.

The lower side of the mentioned centred transversal beam 307 is curved and adapted for accommodating upper part of the rotational locking device 330 of the rotational connection module 300.

The rotational connection module 300 further comprises a socket 320 adapted to be accommodated into lower part of the main body 301 and has a shape adapted the interior of the main body 301 for accommodation therein. As the main body 301, the socket 320 comprises a socket body 321 shaped as a truncated cylinder (also known as cut cylinder or a right circular cylinder with one oblique plane face) wherein on end 322 (lower end) thereof is an oblique surface with the same angle as the oblique surface 302 of the main body 301, e.g. angled 45 degrees.

The socket body 321 is at upper end provided with a circular opening 323 adapted for receiving a rotational locking device 330, and at the other end 322 provided with a smaller circular opening 324 allowing a locking member 332 of the rotational locking device 330 to extend therethrough.

The rotational locking device 330 is formed by a ball joint 331 and a cone-shaped locking member 332 extending in perpendicular direction of the ball joint 331. The cone-shaped locking member 332 is formed by a dual tenon fork connection and locking mechanism, based on similar principles as discussed above. The dual tenon fork connection and locking mechanism 332 has no moving mechanical parts. The dual tenon fork connection and locking mechanism 332 is formed by two parallel extending tenon forks 333a-b connected at rear end thereof by the ball joint 331, wherein the tenon forks 333a-b at the free end thereof are provided with respective wider heads 334a-b. The tenon forks 333a-b extends with decreasing height, while the spacing between the mentioned tenon forks remains constant. The mentioned tenon forks 333a-b exhibit a pretensions force, such that the bending of the two tenon forks 333a-b allows for narrowing of the heads 334a-b when entering an adapted receptor of a connection module 400 and a widening when it clears passage. The wider head 334a-b grips onto an inner surface of the connection module 400.

Accordingly, the socket body 321 is adapted to receive and accommodate partly the rotational locking device 330 by that accommodating the ball joint 331 while the cone-shaped locking mechanism 332 is extending out of the mentioned opening 324 at the oblique side 322.

After insertion of the rotational locking device 330 in the socket 320, the socket 320 is inserted into the main body 301 such that the oblique surfaces 322 and 302 coincides, and wherein the rotational locking device 330 is secured and rotational between the socket 320 and curved lower side of the beam 307 and flange 306 of the main body 301.

Both the main body 301 and socket body 321 are at lower part thereof provided with through holes 309 and 325, respectively, in transversal direction thereof, which coincides when the socket 320 is correctly accommodated in the main body 301. A locking pin or locking pins (not shown) can then be inserted into mentioned holes 309 and 325, locking the two parts together.

In this manner, it is provided a rotational connection module 300, wherein the rotational locking device 330 is spatially rotational to the extent of the spacing between the locking device 330 and opening 324.

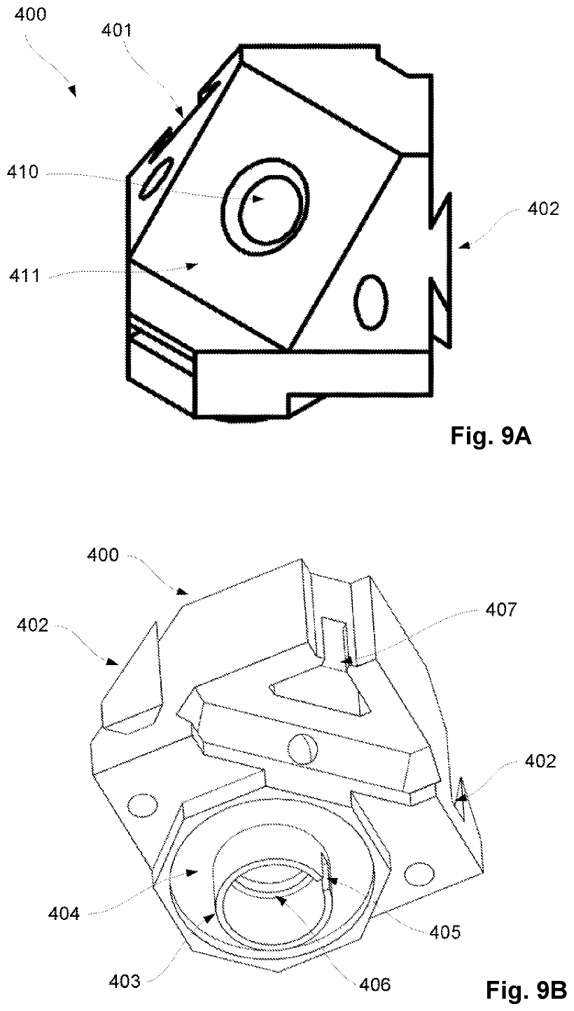

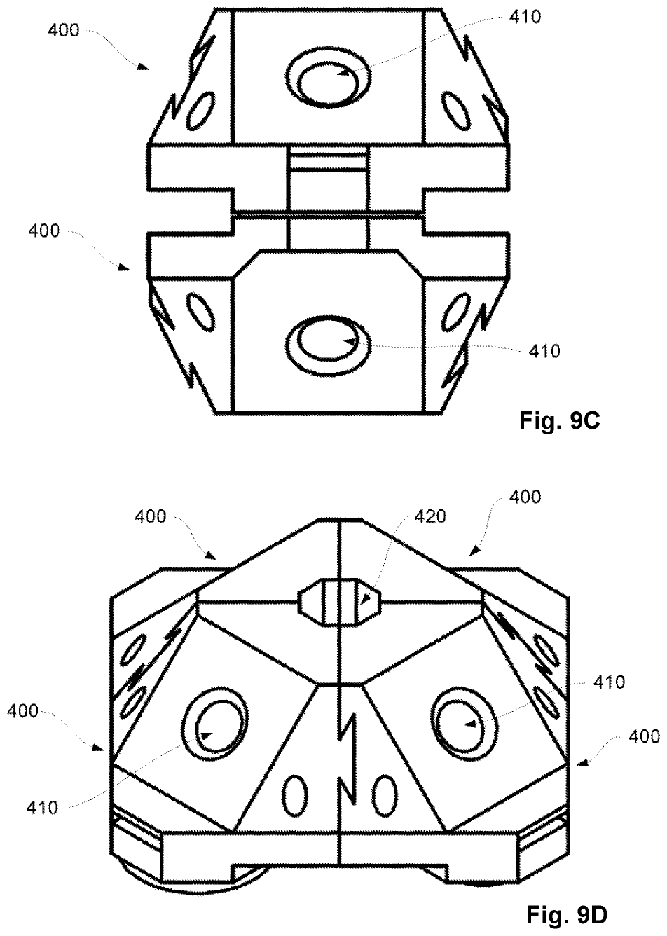

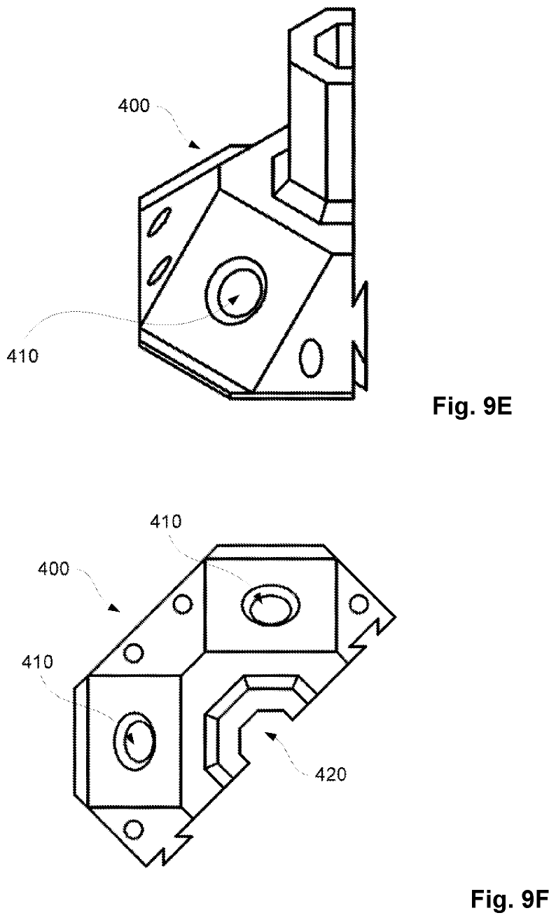

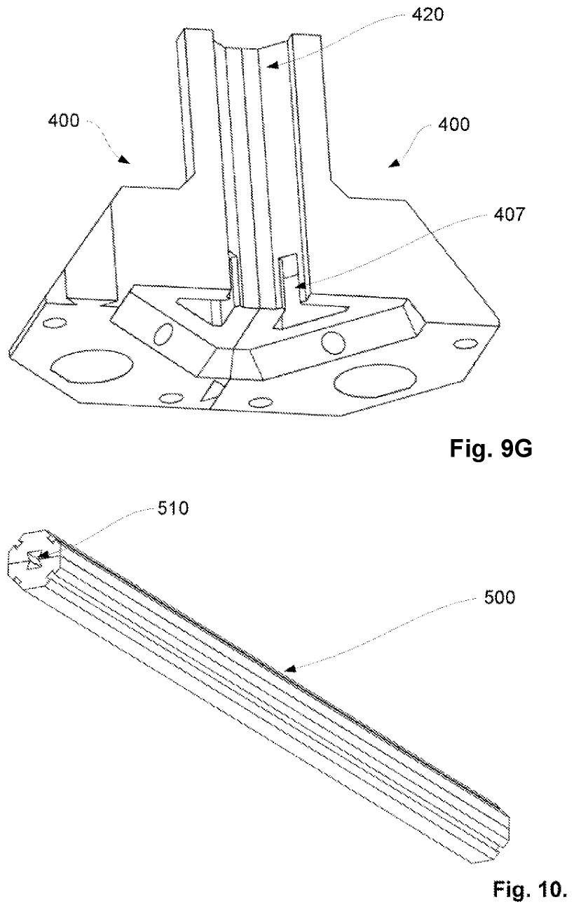

Reference is now made to FIGS. 9A-9G showing principle drawings of a connection module 400. The connection module 400 is a connection module 400 enabling separate use and assembly by several of the mentioned connection modules 400 to form different embodiments.

The connection module 400 is provided with corresponding interlocking profiles 401, 402 at vertical sides (ends) thereof enabling attachment to a corresponding adjoining connection module 400 in the horizontal plane. The connection module 400 is further at lower side thereof provided with corresponding interlocking profiles 403 for attachment to adjoining connection modules 400 with the lower sides facing each other, i.e. laterally reversed or connection to a mentioned CSJA 200. The connection module 400 exhibits an exterior shape that is a combination of two triangle sides and square side in the middle of the triangle sides. In this manner the connection module 400 has a shape enabling, when four identical connection modules 400 are assembled together in the horizontal plane by the mentioned corresponding interlocking profiles 401, 402, as shown in FIG. 9D, the forming of a half-sphere.

According to the disclosure, the square side of the connection module 400 is provided with a through hole 410 providing a connection point at an oblique connection surface 411 thereof, adapted for connection with the rotational locking device 330 of the rotational connection module 300. The oblique connection surface 411 has a corresponding angle as the oblique surface 302 of the rotational connection module 300, such that when the rotational connection module 300 is arranged to the connection module 400, the rotational connection device 300 is arranged mainly perpendicular to the transversal direction of the connection module 400.

The interlocking profile 403 at lower side of the connection module 400 is provided by centered annular flange 403 surrounded by an annular recess 404 adapted for receiving a gasket 800, such as an expansion compression gasket. The gasket 800 will apply a pretension force on the adjoining parts and facilitate secure attachment of the two parts/components. The size and length of the centered annular flange 403 is adapted the size and length mentioned annular recess 241a-b of the CSJA 200 for accommodation therein. The mentioned annular flange 403 is provided with a longitudinally extending slot or recess 405 adapted the size and length of the mentioned projection 242 of the annular flange 241a-b of the CSJA 200.

The mentioned annular flange 403 is at inner end limited by an internal annular flange 406 adapted to limit the length thereof to the tubular solid main body 261 of the mentioned internal locking device 260, and wherein the internal annular flange 406 is adapted to retain the mentioned wider heads 264a-b of the internal locking device 260 extending into the connection module 400.

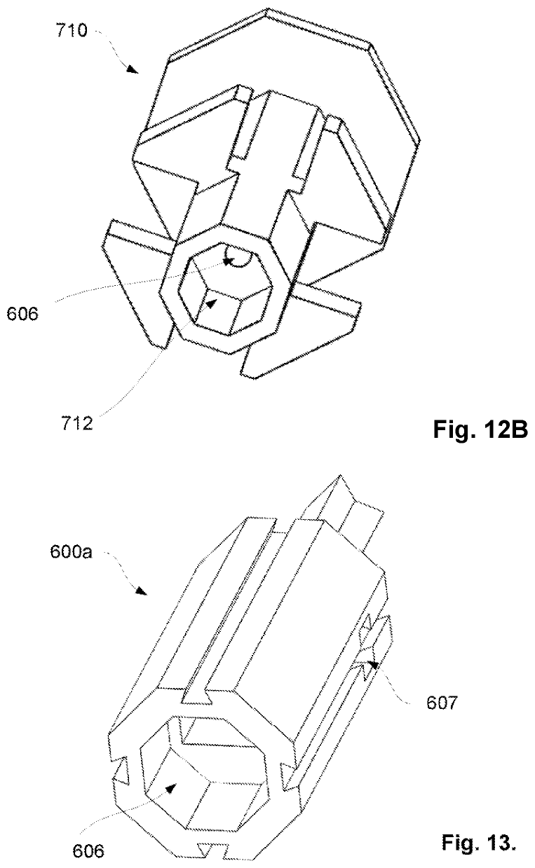

The connection module 400 is further at rear vertical side thereof provided with a locking profile 407 adapted for connection with a corresponding connection interface profile 713, 732 of a mainframe column connection assembly 700 (FIGS. 12A and 12B).

Reference is made to FIGS. 9C and 9D showing examples of two connection modules 400 arranged laterally reversed providing connection points 410 both upwards and downwards, and four connection modules 400 arranged to each other in the horizontal plane providing four upwards connection points 410, as well as forming a centered through hole 420 (connection point) for mainframe column connection assembly 700.

Reference is now made to FIGS. 9E-9G showing alternative embodiments of the connection module 400 similar to the connection module 400 described above. The connection module 400 can be manufactured without the interlocking profiles 403 at lower side. Accordingly, a solution wherein the connection modules 400 only can be connected in the horizontal plane. The shown embodiments further shows that two or more connection modules 400 can be manufactured as one unit, such as in FIGS. 9E and 9F, while the embodiment of FIG. 9G shows the same achieved by the assembly of two or more connection modules 400.

In the embodiment of FIGS. 9E-9G the connection module 400 is further provided with a projection enclosing the centered through hole 420, providing additional support for connection thereto.

Reference is now made to FIG. 10, which is a non-limiting example of a structure element 500 on the form of a column for use as a vertical post or beam in a structure, wherein the structure element at ends thereof is provided with connection means 510 for connection thereto. In the shown example the connection means 510 is provided by a profiled longitudinally extending elongated recess extending from the ends thereof.

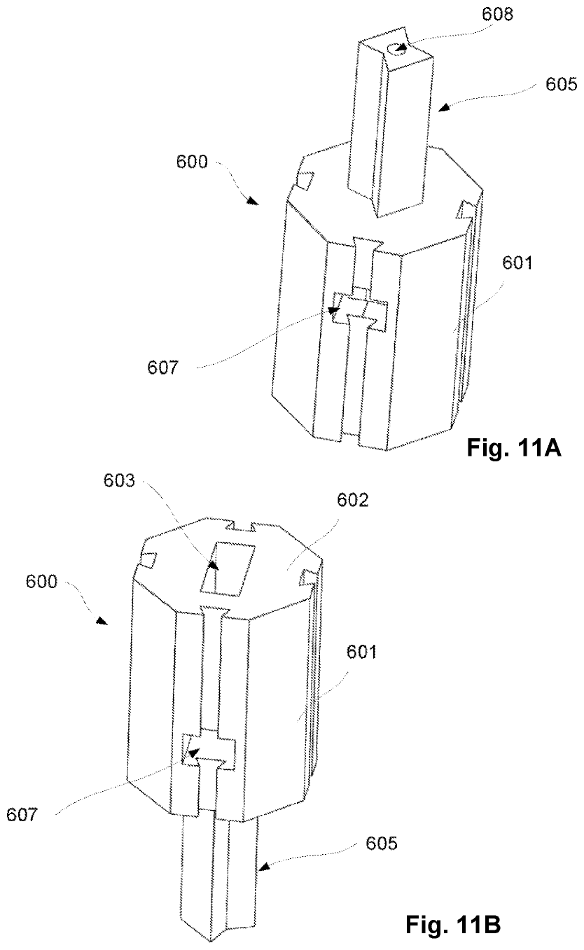

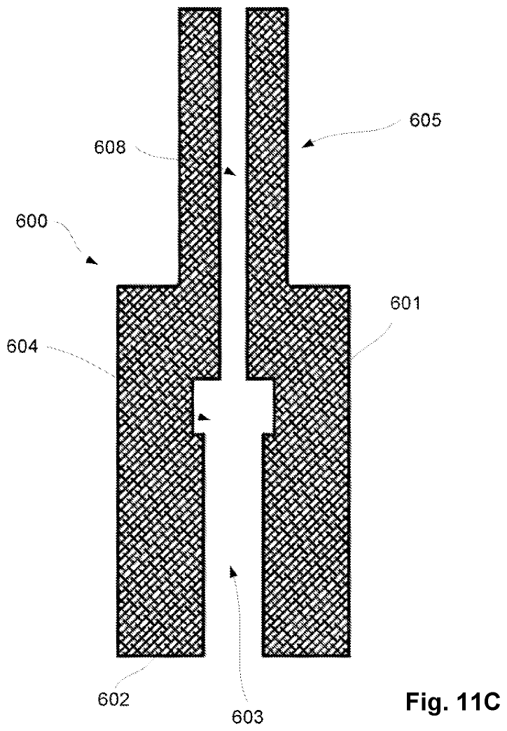

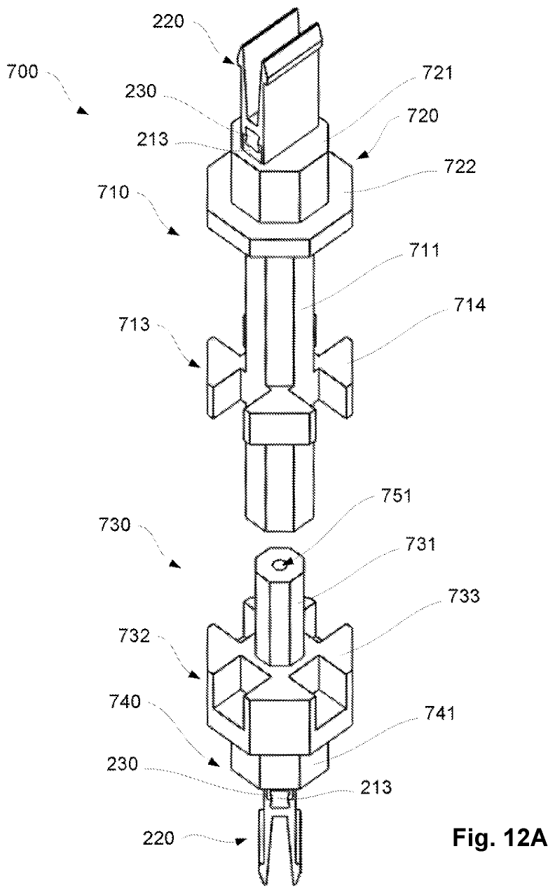

Reference is now made to FIGS. 11A-11C showing principle drawings of a connection interface 600 for connection of a vertical structure element 500 to a connection disc 260, either above or below a CSJA 200. The connection interface 600 is formed by an elongated solid main body 601, which at one end 602 thereof is provided with a with a longitudinally extending centered recess 603, which recess 603 after desired distance ends in an inner spacing 604 with a larger extension in transversal direction of the main body than the longitudinally extending centered recess 603, and thus providing an angled edge. The mentioned longitudinally extending centered recess 603 is adapted to receive and accommodate the mentioned dual tenon fork connection and locking device 263 of the connection disc 260. In the shown embodiment, the mentioned recess 603 and spacing have a rectangular cross-section. The mentioned recess 603 receives the tenon forks 263a-b in a compressed position to allow entering with the wider heads 264a-b and wherein the compressed stated is released when the wider heads 264a-b reaches the inner spacing 604, wherein the wider heads 264a-b grip onto inner surface of the inner spacing 604 locking the parts together.

The connection interface 600 further comprises an elongated connection member 605 extending in longitudinal direction of the other end of the main body 601, wherein the shape and size of the connection member 605 is adapted to be received and accommodated in the connection means of the structure element 500.

The connection interface 600 is further provided with access openings 607 positioned in connection with the inner spacing 604 providing access to the wider heads 264a-b of the tenon forks 263a-b enabling compression of the mentioned tenon forks 263a-b such that the connection interface 600 can be detached.

Reference is now made to FIGS. 12A and 12B showing principle drawings of a mainframe column connection assembly (MCCA) 700 enabling connection of the above described embodiments to a mainframe vertical column structure by means of the mentioned connection module 400. The MCCA 700 comprises upper 710 and lower 730 connection members adapted for detachable connection to each other.

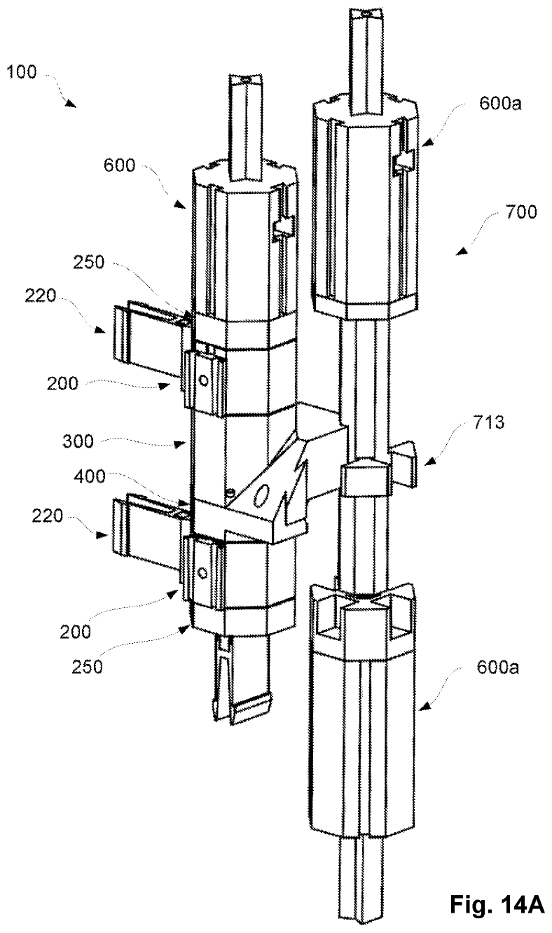

The upper connection member 710 is formed by an elongated main body 711, which at upper end is provided with an upper connection device 720 for arrangement to a vertical structure element 500 via an adapted connection interface 600a (FIGS. 12A-13) and at lower end provided with a longitudinally extending elongated centered profiled recess 712, adapted for receiving and accommodating an upper part of the lower connection member 730.

The upper connection member 710 further comprises an upper connection interface 713 for arrangement of connection modules 400 thereto, which upper profiled connection interface 713 is located at a desired distance from both upper and lower end of the main body 711. According to the shown embodiment, the upper profiled connection interface 713 is formed by multiple protruding profiled connection elements 714 distributed in circumferential direction of the main body 711, which profiled connection elements 714 are adapted to be received and accommodated by the locking profiles 407 of the connection module 400. In the shown embodiment up to four connection modules 400 can be arranged to the upper connection member 710.

The connection device 720 is formed by a disc-shaped profiled body 721 with an exterior diameter larger than the main body 711 and an extension (height) in longitudinal direction of the main body 711, which at lower end (connection end) to the main body 711 is provided with flange 722 having a larger exterior circumference than the disc-shaped profiled body 721a providing a stop surface.

The disc-shaped profiled body 721 is at upper end provided with a transversally extending centred lock bolt sleeve 213, similar to the connection disc 250, enabling arrangement of a dual tenon fork connection and locking device 220 by means of the locking bolt 230, enabling connection with vertical structure element 500 via a connection interface 600a.

The lower connection member 730 is formed by a profiled elongated main body 731 having a size and shape adapted to be received and accommodated in the mentioned profiled recess 712 of the upper connection member 710. The lower connection member 730 further comprises a lower profiled connection interface 732 for arrangement of connection modules 400 thereto, which lower profiled connection interface 732 is located at lower end of the profiled elongated main body 731. According to the shown embodiment, the lower profiled connection interface 732 is formed by a disc-shaped body with multiple formed profiled connection elements 733 distributed in circumferential direction, which profiled connection elements 733 are adapted to be received and accommodated by the locking profiles 407 of the connection module 400. In the shown embodiment up to four connection modules 400 can be arranged to the lower connection member 710.

The lower connection member 730 further comprises a lower connection device 740 for arrangement to a vertical structure element 500 via an adapted connection interface 600a (FIG. 12A-13). The lower connection device 740, similarly as the upper connection device 720, comprises a disc-shaped profiled body 741 arranged to lower part of the disc-shaped connection interface 732, and wherein a transversally extending centered lock bolt sleeve 213 is arranged at lower end of the disc-shaped profiled body 741, enabling arrangement of a dual tenon fork connection and locking device 220 by means of a locking bolt 230, enabling connection with vertical structure element 500 via a connection interface 600a.

Reference is now made to FIG. 13 showing a principle drawing of a connection interface 600a for connection of a vertical structure element 500 to the mentioned upper 710 and lower 730 connection member of the MCCA 700. The connection interface 600a is similar to the connection interface 600 described above, but in addition comprises a longitudinally extending elongated centered profiled recess 606, adapted for receiving and accommodating the disc-shaped profiled body 721 and 741, respectively, and wherein the mentioned longitudinally extending centered recess 603 for the dual tenon fork connection and locking device 220 starts at the bottom of the recess 606.

In this manner, vertical structure elements 500 can be arranged both at upper and lower end of the MCCA 700.

Accordingly, above is described different embodiments enabling arrangement of structure elements in different planes and direction, as well as how these can be arranged to mainframe structures by connection modules.

According to a further embodiment, the components are provided with channels and/or holes or openings for allowing mechanical, electrical or plumbing conduits to run through the components.

The CSJA 200 may be provided with through holes or channels 243 from the interior thereof to exterior thereof in connection with one or more of the connection surfaces 202, especially the ones for arrangement of the connection interfaces 210, but may also be arranged in connection with other surfaces.

The connection interfaces 210 are similarly provided with through holes or openings 219 coinciding with the through holes or channels 243 when arrange to the elongated or disc-shaped main body 201 of the CSJA 200.

The lock bolt sleeve 213, the lock bolt 230 and the main body 222 of the dual for connection and locking device 220 are similarly provide with corresponding through holes 231-233, respectively, coinciding when the mentioned parts are arranged together and forming a continuous hole or channel through the mentioned parts.

The internal locking device 260 is similarly provided with a through hole or channel 266 through the main body 261 as well as corresponding through holes 267 in the tenon forks 263a-b coinciding with holes or channels 243 of the main body 201 of the CSJA 200, and the connection interface 210, lock bolt sleeve 213, the lock bolt 230 and the main body 222 of the dual for connection and locking device 220 if present, providing a continuous hole or channel through these parts.

The rotational connection module 300 is provided with a through hole 340 in the centered transversal beam 307. The rotational locking device 330 is similarly provided with an elongated opening or slit 341 at upper part of the ball joint 331 and a hole or opening 342 in the ball joint 331 opening into the spacing between the tenon forks 333a-b that for a conduit. By means of the elongated opening or slit 341 allowing the rotational locking device 330 to move allowing the rotational locking device 330 to move independently from a conduit or cable running inside the rotational connection module 300.

The connection interfaces 600 and 600a are similarly provided a channel 608 extending from the inner spacing 604 and through the elongated connection member 605, in this manner continuing the channel from components connected thereto.

The upper connection member 710 of the MCCA 700 is also provided with similar holes or channels 750 in the elongated main body 711 and connection device 720 coinciding with the holes or openings in the lock sleeve 213, lock bolt 230 and dual tenon fork connection and locking device 220, if present. The lower connection member 730 is similarly provided holes or channels 751 in the elongated main body 731, the connection interface 732 and lower connection device coinciding with the holes or openings in the lock sleeve 213, lock bolt 230 and dual tenon fork connection and locking device 220, if present.

In this manner cables or conduits for electricity, water, plumbing or similar can be arranged between any structure element and through (into and out of) all the components (modules or devices).

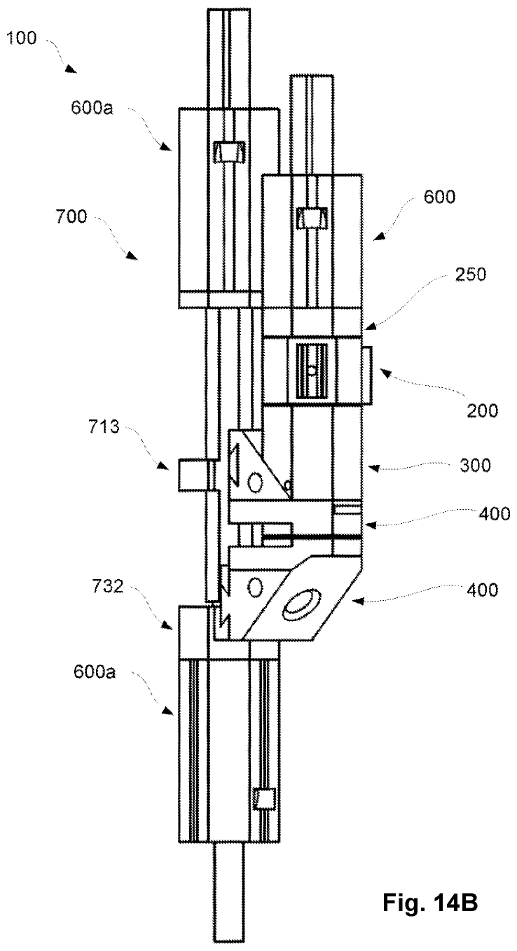

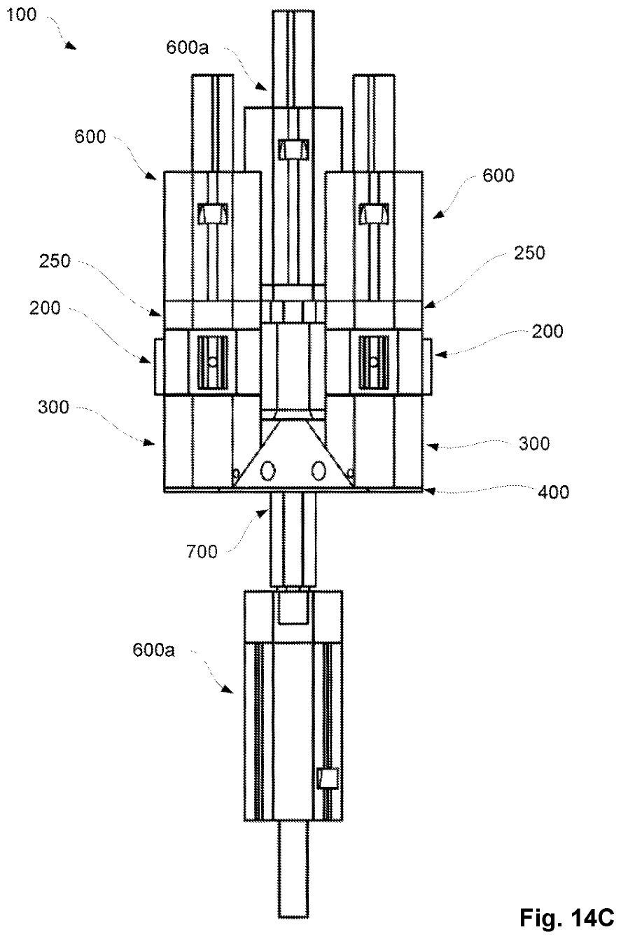

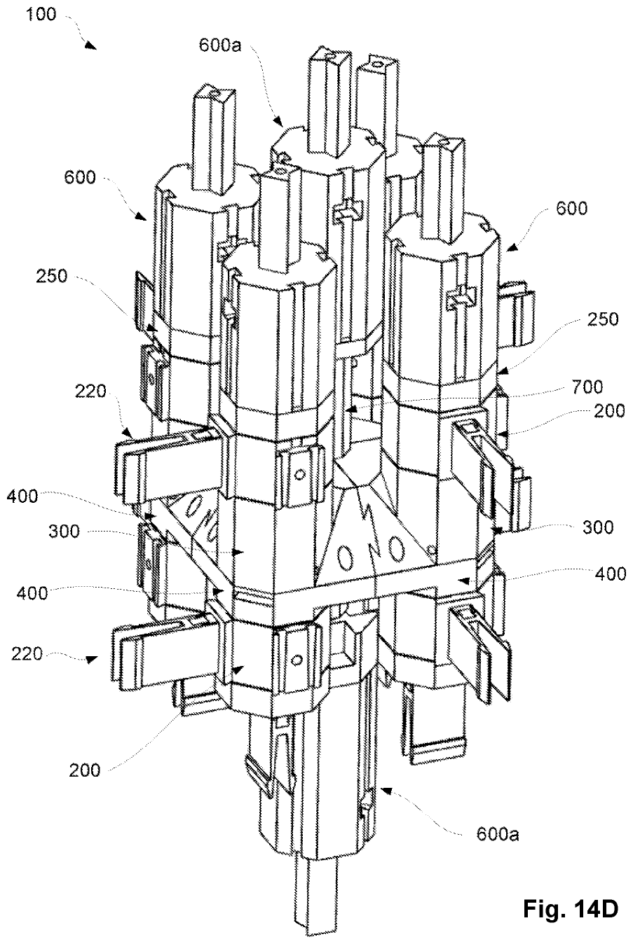

Reference is now made to FIGS. 14A-14D showing different embodiments of the use of the components 100-700 to enable connection to a mainframe structure (not shown).

In FIG. 14A is shown an embodiment where one connection module 400 interfaces with two structure systems, i.e. structure systems extending in two parallel vertical planes, and wherein the CSJA 200 enables connection to structure elements in perpendicular direction (horizontal plane) thereof. In this manner is enabled arrangement of two or more structure system in one or more parallel horizontal planes by the properties of the CSJA 200 that are stacked/arranged above each other. The use of the connection module 400 and the rotational connection device 300 further enables stacking of modules safely.

The same pattern or a different pattern can be arranged around the longitudinal axis of the MMCA 700.

Reference is now made to FIG. 14B showing a second example, wherein there two connection modules 400 are laterally reversed to each other and arranged respectively to upper connection member 710 and lower connection member 730 of the MMCA. In this manner, the upwards and downwards facing connection modules 400 may be used for different purposes. The upwards facing connection module 400 may be used as described above, while the downwards facing for example in the case of taller buildings, allow for connecting modules by lifting them up and connecting bottom-up (instead of stacking modules top-down via crane). In addition, the downwards facing connection module 400 provides opportunities for foundation and piling elements, or intermediary mechanical floors, without modules. As for the prior embodiment, also the same pattern or a different pattern can be arranged around the longitudinal axis of the MMCA 700.

Reference is now made to FIG. 14C showing a third example, wherein the connection module 400 of the embodiment of FIGS. 9E and 9F are arranged to the upper connection interface 713 of the MCCA 700, enabling the arrangement of two vertical structures from the connection module 400, i.e. allowing for two module corners above a single module.

Reference is now made to FIG. 14D showing a fourth example, wherein there are used four connection modules 400 arranged to each other and around upper connection interface 713 of the MCCA 700 providing four parallel vertical structures around a vertical structure and wherein CSJAs 200 are arranged both above and below the connection modules 400 providing multiple positions for connection in the horizontal plane.

Features of the embodiments of the present invention described above can be modified or combined to form modified embodiments within the scope of the attached claims.

1-21. (canceled)

22. A hybrid joint assembly (100), comprising:
at least one joint assembly (200) having an elongated or disc-shaped main body (201) provided with exterior connection surfaces (202) configured for attachment of structure elements (500) extending in a horizontal plane via a connection interface (210), wherein
longitudinal ends of the at least one joint assembly (200) are adapted for connection to structure elements (500) extending in a vertical plane via a connection disc (250) or structure elements (500) extending in a parallel vertical plane via a rotational connection module (300) and at least one connection module (400).

23. The hybrid joint assembly (100) according to claim 22, further comprising internal locking devices (260) configured for detachable locking of the connection disc (250) or rotational connection module (300) to the at least one joint assembly (200).

24. The hybrid joint assembly (100) according to claim 22, wherein the connection interface (210) comprises a dual tenon fork connection and locking device (220) with wider heads (223a-223b) detachably arranged to the connection surface (202) via the connection interface (210) at one end, and configured to be received in a structure element connection interface (600) or an adapted receptor of a structure element (500) for arrangement of a structure element (500) thereto.

25. The hybrid joint assembly (100) according to claim 23, wherein the internal locking device (260) comprises a main body (261) dual tenon fork connection and locking device (263) with wider heads (264a-264b) extending from one end thereof.

26. The hybrid joint assembly (100) according to claim 23, wherein the joint assembly (200), connection disc (250) and rotational connection module (300) are provided with upper recesses or flanges (240, d252, 303), lower recesses or flanges (240, 252, 303) or both adapted to receive and accommodate the main body (261) of the internal locking device (260).

27. The hybrid joint assembly (100) according to claim 23, wherein the joint assembly (200), connection disc (250) and rotational connection module (300) are provided with respective flanges (241a-241b, 255, 306) adapted to retain the wider heads (223a-223b) of the internal locking device (260).

28. The hybrid joint assembly (100) according to claim 23, wherein
the joint assembly (200) is provided with a projection (242) at each end, and
the connection disc (250), internal locking device (250) and connection module (300) are provided with respective recesses (253, 262, 305) adapted for receiving and accommodating the projection at arrangement to the cylinder-shaped joint assembly (200).

29. The hybrid joint assembly (100) according to claim 22, wherein the rotational connection module (300) is adapted for connection to the cylinder-shaped joint assembly (200) at one end and is provided with an oblique surface (302) wherein a rotational locking device (330) is arranged at another end.

30. The hybrid joint assembly (100) according to claim 29, wherein
the rotational locking device (330) comprises a ball joint (331) and a cone-shaped locking member (332),
the ball-joint (331) is accommodated spatially rotational in the rotational locking device (330), and
the cone-shaped locking member (332) protrudes from the oblique surface (302).

31. The hybrid joint assembly (100) according to claim 30, wherein the cone-shaped locking member (332) is a dual tenon fork connection and locking mechanism with wider heads (334a-334b).

32. The hybrid joint assembly (100) according to claim 22, wherein the connection module (400) is provided with corresponding interlocking profiles (401, 402) at vertical sides thereof enabling attachment to corresponding adjoining connection modules (400).

33. The hybrid joint assembly (100) according to claim 32, wherein the connection module (400) is provided a corresponding interlocking profile (403) at a lower side thereof enabling attachment to adjoining connection modules (400) with the lower sides facing each other or connection to longitudinal ends of the cylinder-shaped joint assembly (200).

34. The hybrid joint assembly (100) according to claim 33, wherein the interlocking profile (403) is provided with a slot or recess (405) adapted for accommodating the projection (242) of the cylinder-shaped joint assembly (200).

35. The hybrid joint assembly (100) according to claim 23, wherein the interlocking profile (403) at the inner end is limited by an internal annular flange (406) adapted to retain the wider heads (264a-264b) of the internal locking device (260).

36. The hybrid joint assembly (100) according to claim 22, wherein
the connection module (400) includes a through hole (410) at an oblique surface (411) adapted for connection with the cone-shaped locking member (332) of the rotational connection module (300), and
the oblique surface (411) corresponds to the oblique surface (302) of the rotational connection module (300).

37. The hybrid joint assembly (100) according to claim 22, further comprising at least one mainframe column connection assembly (700) comprising an upper profiled connection interface (713) and a lower profiled connection interface (732) and formed as one piece or an upper connection members (710) and lower connection member (730) adapted for detachable connection to each other.

38. The hybrid joint assembly (100) according to claim 37, wherein the mainframe column connection assembly (700) is provided with an upper connection device (720) at an upper end for arrangement to a vertical structure element (500) via an adapted connection interface (600a) or at a lower end provided with a connection device (740) for arrangement to a vertical structure element (500) via an adapted connection interface (600a) or both.

39. The hybrid joint assembly (100) according to claim 37, wherein the upper profiled connection interface (713) and lower profiled connection interface (732) are adapted for arrangement of connection modules (400) thereto.

40. The hybrid joint assembly (100) according to claim 37, wherein the upper connection member (710) is provided with longitudinally extending elongated centered profiled recess (712) at a lower end, adapted for receiving and accommodating an upper part of the lower connection member (730).

41. The hybrid joint assembly (100) according to claim 33, wherein the connection module (400) is provided with a locking profile (407) at a rear vertical side thereof adapted for connection to the corresponding profiled connection interface (713, 732) of a mainframe column connection assembly (700).

42. The hybrid joint assembly (100) according to claim 24, wherein the connection interface (600, 600a) is provided with recesses (603, 604) at one end for receiving the dual tenon for the connection and locking device (220) and a connection member (605) at the other end for connection to a structure element (500).
